(19) United States
(12) Patent Application Publication
(10) Pub. No.: US 2023/0349743 A1
(43) Pub. Date: Nov. 2, 2023

(54) METHOD, SYSTEM, AND ELECTRONICS FOR CORRECTING A CORIOLIS FLOW METER MEASUREMENT FOR TEMPERATURE EFFECTS

(71) Applicant: MICRO MOTION, INC., Boulder, CO (US)

(72) Inventors: Aart R. PRUYSEN, Ede (NL); Robert Barclay GARNETT, Boulder, CO (US); Andrew Timothy PATTEN, Boulder, CO (US)

(73) Assignee: MICRO MOTION, INC., Boulder, CO (US)

(21) Appl. No.: 18/001,529

(22) PCT Filed: Jun. 24, 2020
(86) PCT No.: PCT/US2020/039301

§ 371 Date: Dec. 12, 2022

(51) Int. Cl. G01F 15/02; G01F 1/84

(52) U.S. Cl. CPC G01F 15/02; G01F 1/8431

(57) ABSTRACT

A method (300), system (400), and electronics (20) for correcting a mass flow value in measured using a Coriolis flow meter (100) for temperature effects at a known fluid temperature temp below 0 C are provided. The method comprises receiving a known fluid density ρ_{indic}, receiving the fluid temperature temp, receiving a time period Tp, determining a Young's modulus temperature correction for density TFy_{D} based on the known fluid density ρ_{indic}, the known fluid temperature temp, and the time period Tp, determining a Young's modulus temperature correction for mass flow TFy_{M} based on a temperature correction constant k and Young's modulus temperature correction for density TFy_{D}, and correcting the mass flow value \dot{m} using the Young's modulus temperature correction for mass flow TFy_{M}.

### TECHNICAL FIELD

The present Application is directed towards Coriolis flow meters, and more particularly, to correcting a Coriolis flow meter measurement for temperature effects.

### BACKGROUND

Coriolis mass flowmeters utilize Coriolis forces induced by fluid flowing through one or more vibrating tubes to measure mass flow rate. FIG. 1 depicts example Coriolis flow meter 100 comprising a meter assembly 10 and meter electronics 20. Meter assembly 10 responds to changes in a process fluid flow. Meter electronics 20 is connected to meter assembly 10 via leads 102, and provides density, volumetric flow rate, and mass flow rate information to operators over meter electronics interface 26, in addition to other information.

Meter assembly 10 includes manifolds 150 and 150′, flanges 103 and 103′, two parallel flow tubes 130 and 130′, driver 180, and velocity pick-off sensors 170L and 170R. Flow tubes 130 and 130′ bend at two symmetrical locations along their length and are essentially parallel throughout their length. Brace bars 140 and 140′ serve to define an axis about which each flow tube oscillates.

When flanges 103 and 103′ are connected via inlet end 104 and exit end 104′ to a process line (not shown), process fluid enters inlet end 104 of the meter through flange 103 and is conducted through manifold 150. Manifold 150 divides and routes the process fluid through flow tubes 130 and 130′. Upon exiting flow tubes 130 and 130′, the process fluid is recombined in a single stream by manifold 150′ and routed to outlet end 104′, connected by flange 103′ to the process line (not shown).

Both flow tubes 130 and 130′ are driven by driver 180 in opposite directions in a first out-of-phase bending mode of the flowmeter. Driver 180 may comprise any one of many well-known arrangements, such as a magnet mounted to flow tube 130′ and an opposing coil mounted to flow tube 130 and through which an alternating current is passed for vibrating both flow tubes. A suitable driver voltage is applied by meter electronics 20 to driver 180. In further embodiments, Coriolis flow meter 100 may comprise more than one driver 180, providing a multiple-input arrangement that can generate other bending modes.

While Coriolis flow meter 100 depicts a dual, curved flow tube design, this is not intended to be limiting. Those of skill understand that other examples of Coriolis flow meters 100 may include one, or any number of flow tubes. Those of skill will further understand that other Coriolis flow meters may include straight flow tubes, or any other configuration.

Meter electronics 20 provides the drive signal to driver 180 to vibrate flow tubes 130 and 130′ over leads 102. Meter electronics 20 receives the left and right velocity signals from velocity pick-off sensors 170L and 170R over leads 102, which can be used to compute the mass flow rate, volumetric rate, and/or density information for the flow passing through meter assembly 10.

The left and right velocity signals from pick-off sensors 170L and 170R are used to determine a phase difference ΔT between the pick-off sensors 170L and 170R representing the Coriolis forces on the flow tubes. The phase difference ΔT is used to determine a mass flow value \dot{m} using Equation 1:

\dot{m}=FCF(ΔT−ΔT_{zero}), (Equation 1)

where FCF, the Flow Calibration Factor, and ΔT₀, the zero offset, are determined during factory calibration. The FCF captures the stiffness of the one or more flow tubes 130, 130′, which is directly proportional to the mass flow rate of the fluid flowing through the tube. The FCF is determined by flowing water at ambient conditions through the Coriolis mass flowmeter and comparing the indicated mass to the mass measured by a reference flow meter.

Corrections are typically made to the Coriolis flow meter 100 mass flow measurements after installation at a customer site to account for differences between the customer site and factory environmental conditions. For example, changes in temperature and fluid pressure can change the stiffness of flow tubes 130, 130′, which can introduce errors in the meter mass flow and density measurements.

Temperature corrections required for mass flow and density measurements higher than 0 C are different than the temperature corrections required below 0 C temperatures. The temperature correction made to measured mass flow values m for changes in stiffness due to Young's modulus higher than 0 C is approximately linear. For temperatures below 0 C, corrections to mass flow measurement m are typically better represented by a polynomial equation.

It has been empirically observed that the temperature correction for density measurements is not the same as the temperature correction based on mass flow measurements for temperatures between 0 and 50 C. However, it has been difficult to characterize the change in flow tube stiffness based on Young's modulus below 0 C due to the limitations in flow rate available in cryogenic calibration facilities. Thus far, it has only been possible to acquire empirical data to characterize changes in flow tube stiffness based on temperature for smaller flow meters, or those with flow tubes that are 4 inches or smaller.

There is a demand for more precise mass flow measurements at sub-zero and cryogenic temperatures. One possible application is high volume flows of liquified natural gas at a temperature of −160 C.

It is highly desirable to provide more accurate fluid measurements with Coriolis flow meters at sub-zero and cryogenic temperatures.

### SUMMARY

A method for correcting a mass flow value \dot{m} measured using a Coriolis flow meter for temperature effects at a known fluid temperature temp below 0 C is provided. The method comprises receiving a known fluid density ρ_{ref}; receiving the known fluid temperature temp, receiving a time period Tp, determining a Young's modulus temperature correction for density TFy_{D} based on the known fluid density ρ_{ref}, the known fluid temperature temp, and the time period Tp, determining a Young's modulus temperature correction for mass flow TFy_{M} based on a temperature correction constant k and the Young's modulus temperature correction for density TFy_{D}, and correcting the mass flow value \dot{m} using the Young's modulus temperature correction for mass flow TFy_{M}.

A system for correcting a mass flow value \dot{m} measured using a Coriolis flow meter for temperature effects at a known fluid temperature temp below 0 C is provided. The system comprises a fluid density receiving module configured to receive a known fluid density ρ_{ref}, a fluid temperature receiving module configured to receive the known fluid temperature temp, a period determination module configured to receive a time period Tp, a Young's modulus temperature correction for density determination module configured to determine a Young's modulus temperature correction for density TFy_{D} based on the known fluid density ρ_{ref}, the known fluid temperature temp, and the time period Tp, a Young's modulus temperature correction for mass flow determination module configured to determine a Young's modulus temperature correction for mass flow TFy_{M} based on a temperature correction constant k and the Young's modulus temperature correction for density TFy_{D}, and a mass flow correction module configured to correct the mass flow value \dot{m} using the Young's modulus temperature correction for mass flow TFy_{M}.

A meter electronics for correcting a mass flow value \dot{m} measured using a meter assembly of a Coriolis flow meter for temperature effects at a known fluid temperature temp below 0 C is provided. The meter electronics comprising a system processor is configured to receive a known fluid density ρ_{ref}, receive the known fluid temperature temp, receive a time period Tp, determine a Young's modulus temperature correction for density TFy_{D} based on the known fluid density ρ_{ref}, the known fluid temperature temp, and the time period Tp, determine a Young's modulus temperature correction for mass flow TFy_{M} based on a temperature correction constant k and Young's modulus temperature correction for density TFy_{D}, and correct the mass flow value \dot{m} using the Young's modulus temperature correction for mass flow TFy_{M}.

### Aspects

According to a further aspect, the time period Tp may be determined based on a measured fluid density ρ_{indic}.

According to a further aspect, the method may further comprise receiving a phase difference ΔT, and determining the Young's modulus temperature correction for density TFy_{D} may be further based on the phase difference ΔT.

According to a further aspect, the method may further comprise receiving a fluid pressure P, and the Young's modulus temperature correction for density TFy_{D} may be further based on the fluid pressure P.

According to a further aspect, the method may further comprise determining an expansion temperature correction for density TFe, and the Young's modulus temperature correction for density TFy_{D} may be further determined based on the expansion temperature correction for density TFe based on a known temperature temp_{ref}.

According to a further aspect, the temperature correction constant k may be between 0.8 and 1.2.

According to a further aspect, the temperature correction constant k may be one.

According to a further aspect, correcting a mass flow value h using the Young's modulus temperature correction for mass flow TFy_{M} may further comprise determining a mass error value Errorₘ using the Young's modulus temperature correction for mass TFy_{M}.

According to a further aspect, the fluid density receiving module may be further configured to determine a measured fluid density ρ_{indic}, and the period determination module is further configured to determine the time period Tp based on the measured fluid density ρ_{indic}.

According to a further aspect, the system may further comprise a phase difference determination module configured to determine a phase difference ΔT, and the Young's modulus temperature correction for density determination module may further be configured to determine the Young's modulus temperature correction for density TFy_{D} based on the phase difference ΔT.

According to a further aspect, the system may further comprise a fluid pressure determination module configured to determine a measured fluid pressure P_{indic}, and the Young's modulus temperature correction for density determination module may be further configured to determine the Young's modulus temperature correction for density TFy_{D} based on the fluid pressure P.

According to a further aspect, the system may further comprise an expansion temperature correction module configured to determine an expansion temperature correction for density TFe based on a known temperature temp_{ref}, and the Young's modulus temperature correction for density module may be further configured to determine the Young's modulus temperature correction for density TFy_{D} based on the expansion temperature correction for density TFe.

According to a further aspect, the temperature correction constant k may be between 0.8 and 1.2.

According to a further aspect, the temperature correction constant k may be one.

According to a further aspect, the mass flow correction module may be further configured to determine a mass error value Errorₘ using the Young's modulus temperature correction for mass TFy_{M}.

According to a further aspect, the time period Tp may be determined based on a measured fluid density ρ_{indic}.

According to a further aspect, the system processor may be further configured to receive a phase difference ΔT, and determine the Young's modulus temperature correction for density TFy_{D} may be further based on the phase difference ΔT.

According to a further aspect, the system processor may be further configured to receive a fluid pressure P, and the Young's modulus temperature correction for density TFy_{D} may be further based on the fluid pressure P.

According to a further aspect, the system processor may be further configured to determine an expansion temperature correction for density TFe, and the Young's modulus temperature correction for density TFy_{D} may be further determined based on the expansion temperature correction for density TFe based on a known temperature temp_{ref}.

According to a further aspect, the temperature correction constant k may be between 0.8 and 1.2.

According to a further aspect, the temperature correction constant k may be one.

According to a further aspect, correcting a mass flow value \dot{m} using the Young's modulus temperature correction for mass flow TFy_{M} may further comprise determining a mass error value Errorₘ using the Young's modulus temperature correction for mass TFy_{M}.

### BRIEF DESCRIPTION OF THE DRAWINGS

The same reference number represents the same element on all drawings. The drawings are not necessarily to scale.

FIG. 1 depicts Coriolis flow meter 100;

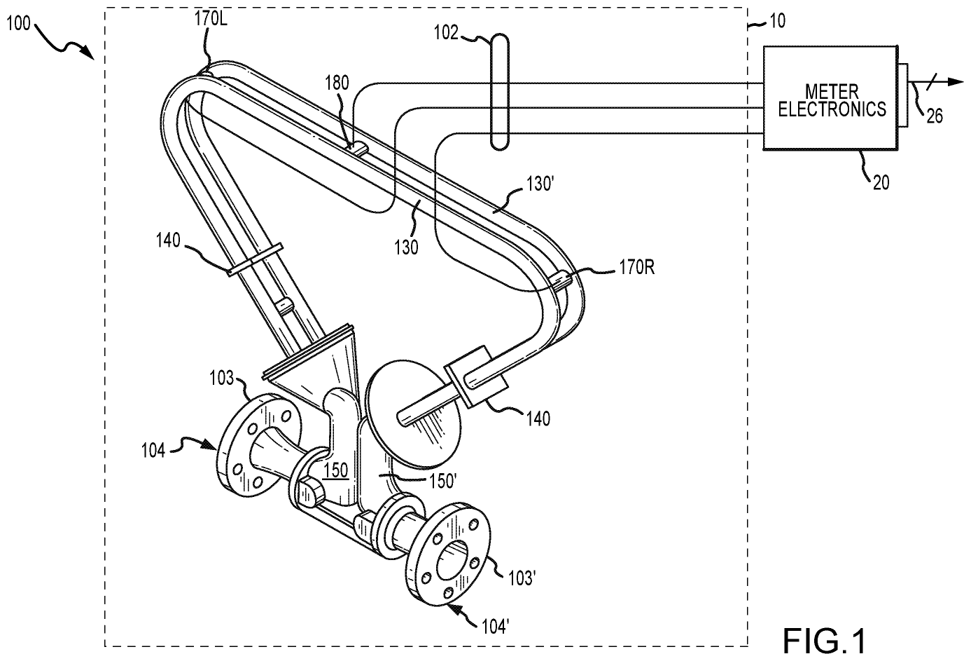

FIG. 2 depicts system 200, in accordance with an embodiment;

FIG. 3 depicts method 300, in accordance with an embodiment; and

FIG. 4 depicts system 400, in accordance with an embodiment.

### DETAILED DESCRIPTION

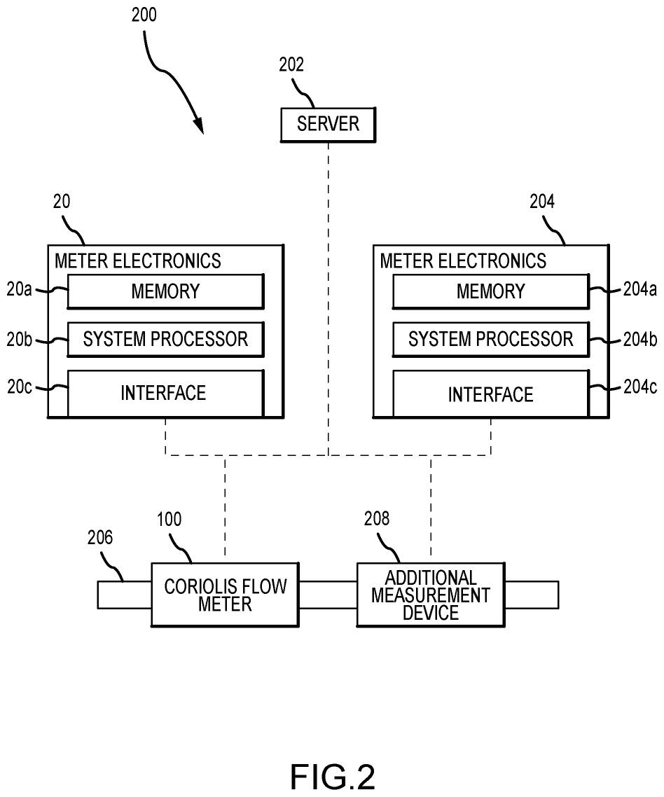

FIGS. 2-4 and the following description depict specific examples to teach those skilled in the art how to make and use the best mode of the Application. For the purpose of teaching inventive principles, some conventional aspects have been simplified or omitted. Those skilled in the art will appreciate variations from these examples that fall within the scope of the Application. Those skilled in the art will appreciate that the features described below may be combined in various ways to form multiple variations of the Application. As a result, the Application is not limited to the specific examples described below, but only by the claims and their equivalents.

FIG. 2 depicts system 200 in accordance with an embodiment. System 200 may be used for temperature correcting a mass flow value \dot{m} measured using a Coriolis flow meter for temperature effects at a fluid temperature below 0 C. For example, system 200 may be used to provide temperature corrections, such as those due to Young's modulus, the modulus of elasticity, thermal expansion, or pressure effects, based on temperature on the mass flow value \dot{m} measured with a Coriolis flow meter.

System 200 includes Coriolis flow meter 100, meter electronics 20, and process conduit 206. Process conduit 206 carries a flow of fluid to be measured by Coriolis flow meter 100.

Meter electronics 20 may be used to generate a mass flow value \dot{m} for the fluid measured with meter assembly 10 of Coriolis flow meter 100, or to temperature correct a mass flow value \dot{m} obtained using meter assembly 10. Meter electronics 20 includes a memory 20a, a system processor 20b, and an interface 20c.

Memory 20a comprises an electronically readable medium or a computer readable medium configured to store computer program instructions. In examples, memory 20a may include a non-transitory medium. Computer program instructions stored on the memory 20a may perform a portion or all of the steps described in relation to method 300 or execute a portion or all of the modules of system 400.

System processor 20b may be configured to execute computer instructions, which perform a portion or all of the steps described in relation to method 300 or execute a portion or all of the modules described in relation to system 400. In embodiments, system processor 20b may include a single, or any multiple number of processors, as will be understood by those of skill in the art.

Interface 20c is configured to communicate with meter assembly 10 of Coriolis flow meter 100. Interface 20c may be configured to communicate with devices external to electronics 20, such as, for example, a pressure sensor, a temperature sensor, or any other sensor known to those of skill.

In embodiments, system 200 may comprise an additional measurement device 208. In embodiments, additional measurement device 208 may comprise a device capable of providing density measurements, such as a densitometer, a gas chromatograph, an additional Coriolis meter, or any other type of measurement device known to those of skill. In embodiments, additional measurement device 208 may include a corresponding meter electronics 204, as depicted in FIG. 2. Like meter electronics 20, meter electronics 204 may comprise a memory 204a, system processor 204b, and an interface 204c. In further embodiments, however, additional measurement device 208 may provide signals and information directly to interface 20c of meter electronics 20.

In further embodiments, system 200 may include a server 202. In embodiments, server 202 may be in communication with interface 20c of meter electronics 20 and/or interface 204c of meter electronics 204. Any portion of the steps described in relation to method 300 or the modules described in relation to system 400 may be stored or executed on server 202.

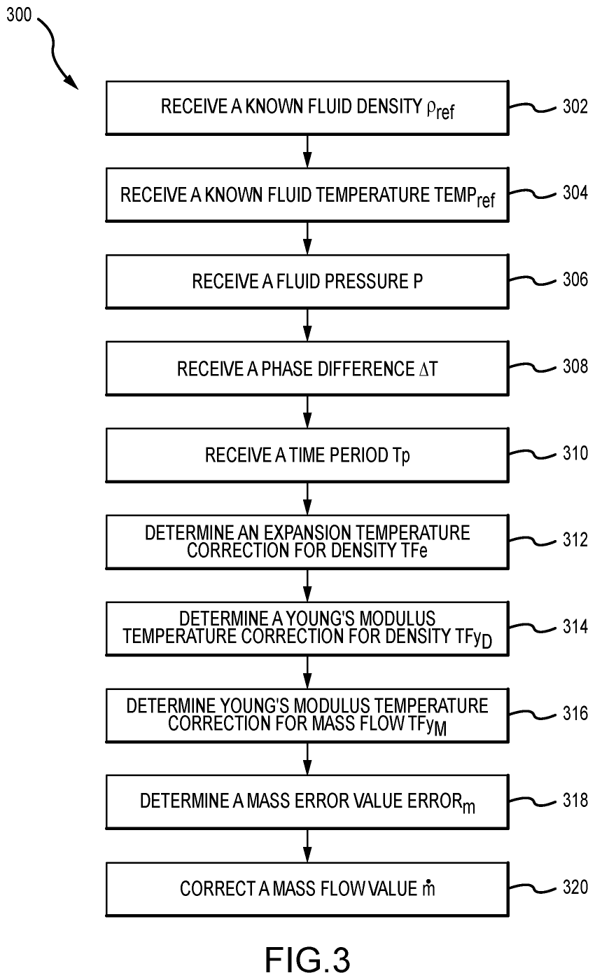

FIG. 3 depicts a method 300 in accordance with an embodiment. Method 300 may be used for correcting a mass flow value \dot{m} measured using a Coriolis flow meter for temperature effects at a known fluid temperature temp_{ref} below 0 C. For example, method 300 may be used to provide measurement corrections, such as those that correct for changes associated with changes in Young's modulus, the modulus of elasticity, thermal expansion, or pressure effects, based on temperature on the mass flow value \dot{m} measured with Coriolis flow meter 100.

Method 300 begins with step 302. In step 302, a known fluid density ρ_{ref} is received. Method 300 continues with step 304. In step 304, the known fluid temperature temp is received. The known fluid density ρ_{ref} and the known fluid temperature temp may be well understood due to the nature of the fluid being measured.

Method 300 continues with step 310. In step 310 a time period Tp is received. Time period Tp is the period of time of the vibrating flow tube 130, 130′.

In embodiments, time period Tp may be measured directly using a vibration sensor coupled to a flow tube 130, 130′, including, for example, one or both of left and right velocity pick-off sensors 170L and 170R of Coriolis flow meter 100.

In further embodiments of step 310, however, time period Tp may be determined indirectly based on the measured fluid density ρ_{indic}, the phase difference ΔT, and a fluid pressure P as follows.

In the method where time period Tp is determined indirectly, step 310 may further comprise steps 306 and 308. In step 306, a fluid pressure P may be received. In embodiments, fluid pressure P may comprise a fluid pressure determined using a pressure transducer positioned just upstream or downstream of Coriolis flow meter 100 in process conduit 206. In further embodiments, however, fluid pressure P may comprise a pressure measurement that is internal to Coriolis flow meter 100, or any other fluid pressure measurement known to those of skill in the art. In embodiments, fluid pressure P may comprise a known or estimated fluid pressure.

In step 308, a phase difference ΔT may be received. In embodiments, the phase difference ΔT may be determined using velocity pick-off sensors 170L and 170R of Coriolis flow meter 100. In further embodiments, however, phase difference ΔT may be determined indirectly using the measured mass flow value \dot{m}, FCF, a combined temperature factor TF, and a fluid temperature temp, as will be understood by those of skill.

In embodiments, the measured fluid density ρ_{indic} may be measured with a densitometer. For example, the measured fluid density ρ_{indic} may be received from additional measurement device 208 in system 200, which may comprise a densitometer.

In further embodiments, additional measurement device 208 in system 200 may comprise a gas chromatograph that may provide the measured fluid density ρ_{indic}.

Coriolis flow meter 100 is typically calibrated at factory conditions at a temperature between 20-30 C. In many cases, a Coriolis flow meter is calibrated using two fluids, such as ambient air and water, by determining a mass flow value \dot{m} and a measured fluid density ρ_{indic} value for each fluid. Using these measured values for mass flow value \dot{m} and a measured fluid density ρ_{indic}, it is possible to determine calibration constants K₁ and K₂, one constant for each respective fluid.

Calibration values C₁ and C₂, which are valid for a temperature of 0 C and a pressure of 0 barg, can then be calculated using calibration constants K₁ and K₂ via Equations 2 and 3. Calibration value C₁ is proportional to inertia moment and inversely proportional to flow area of the flow tube 130, 130′:

$${C}_{1} = \frac{{D}_{2} - {D}_{1}}{( {K}_{2}^{2} - {K}_{1}^{2} )} . \qquad ( Equation 2 )$$

Calibration value C₂ is proportional to the mass of flow tube 130, 130′ material divided by fluid volume:

$${C}_{2} = \frac{{K}_{1}^{2}}{( {K}_{2}^{2} - {K}_{1}^{2} )} \qquad ( Equation 3 )$$

In Equations 2 and 3, D₁ is the outer diameter of flow tube 130, 130′, and D₂ is the inner diameter of flow tube 130, 130′.

A measured fluid density ρ_{indic} may be determined using Equation 4:

$${ρ}_{indic} = ( \frac{{TF}_{d} * {T}^{2} - {K}_{1}^{2}}{{K}_{2}^{2} - {K}_{1}^{2}} ) * ( {D}_{2} - {D}_{1} ) + {D}_{1} - FD * {( Δ T )}^{2} * 1 {0}^{- 9} + pcd * P . \qquad ( Equation 4 )$$

In Equation 4, TF_{d} is a combined temperature correction coefficient for density. FD is a constant to correct the measured fluid density ρ_{indic} under flowing conditions, as will be understood by those of skill in the art. In Equation 4, pcd is a pressure correction for density.

Equation 4 can be re-arranged to Equation 5:

$${T}_{p}^{2} = \frac{\frac{\begin{matrix}( {ρ}_{indic} + FD ⋆ {( Δ T )}^{2} ⋆ {10}^{- 9} + pcd ⋆ P - {D}_{1} ) \\ ( {K}_{2}^{2} - {K}_{1}^{2} )\end{matrix}}{( {D}_{2} - {D}_{1} )} + {K}_{1}^{2}}{{TF}_{d}} \qquad ( Equation 5 )$$

In embodiments, time period squared Tₚ² may be determined based on measured fluid density ρ_{indic}, fluid pressure P, and phase difference ΔT using Equation 5. In further embodiments, however, the flow effect on the measured fluid density ρ_{indic} represented by the FD*(ΔT)²*10⁻⁹ term in Equation 5, may be very small, and therefore ignored. The pressure correction for density pcd may also be small, and therefore Equation 5 may be further simplified by making pcd equal to zero. This may provide for the simplified embodiment of Equation 6:

$${T}_{p}^{2} = \frac{\frac{( {ρ}_{indic} ) ( {K}_{2}^{2} - {K}_{1}^{2} )}{( {D}_{2} - {D}_{1} )} + {K}_{1}^{2}}{{TF}_{d}} \qquad ( Equation 6 )$$

According to Equation 6, time period squared Tₚ² may be determined based on measured fluid density ρ_{indic}.

Method 300 continues with step 314. In step 314, Young's modulus temperature correction for density TFy_{D} is determined. Young's modulus is affected by material expansion and the changing geometry of the flow tube due to temperature and, to a lesser degree, pressure.

In embodiments, Young's modulus temperature correction for density TFy_{D} may be determined using any method known to those of skill in the art. In further embodiments, however, Young's modulus temperature correction for density TFy_{D} may be determined based on the known fluid density ρ_{ref}, the fluid temperature temp, and the time period Tp.

For example, a known fluid density ρ_{ref} is related to Young's modulus E(temp,P) via exact theory according to Equation 7:

$${ρ}_{ref} = \frac{12.36}{64 * {π}^{2}} * \frac{( {D}_{o}^{4} - {D}_{i}^{4} )}{{L}^{4} * {D}_{i}^{2}} * E ( temp , P ) ⋆ {T}_{p}^{2} - \frac{( {D}_{o}^{2} - {D}_{i}^{2} )}{{D}_{i}^{2}} * {ρ}_{tube material} - FD * {( Δ T )}^{2} * {10}^{- 9} . \qquad ( Equation 7 )$$

In Equation 7, FD is the flow effect on density, L is the length of the flow tube 130, 130′, Dₒ is the outer diameter of flow tube 130, 130′, and Dᵢ is the inner diameter of flow tube 130, 130′. When the temperature temp is 0 C and the fluid pressure P is 0 barg, Equation 7 may be re-written as Equation 8:

$${ρ}_{ref} = \frac{{TF}_{y} * {PF}_{C 1} * {C}_{1} * {T}_{p}^{2}}{{( {TF}_{e} )}^{2}} - \frac{{C}_{2}}{{( TFe )}^{3} * {PF}_{C 2}} - FD * {( Δ T )}^{2} * 1 {0}^{- 9} , \qquad ( Equation 8 )$$

where PF_{c1} is a pressure factor which represents a combination of Young's modulus and geometry changes due to fluid pressure PF_{c1}=1+pc_{c1}*P, with pc_{c1} being the pressure coefficient for constant C₁. In Equation 8, PF_{C2} is a pressure factor which relates to the change of fluid volume due to pressure PF_{C2}=1+pc_{C2}*P, where pc_{C2} is a pressure coefficient for constant C₂. For example, for Micro Motion flow meter model CMF400, pc_{c1} is 3.45*10⁻⁵, pc_{c2} is 0.99*10⁻⁵, and the pressure effect is −0.145 kg/m³/bar.

In Equation 8, TF_{y} is the temperature factor due to Young's modulus. At cryogenic temperatures, the temperature factor due to Young's modulus TF_{y} may be non-linear. For example, in the Journal of Applied Physics article, “Stainless steel elastic constants at low temperatures” written by Mr. H. M. Ledbetter, in March 1981, the polynomial of Equation 9 is proposed for stainless steel at cryogenic temperatures:

TF_{y}=1−tc_{y}*temp−3.5*10⁻⁷*(temp)²−2*10⁻⁹*(temp)³−1.3*10⁻¹¹*(temp)⁴. (Equation 9)

In Equation 9, temp represents a temperature, which can be a known or a measured temperature. In embodiments of step 314, known temperature temp_{ref} may be used to determine the temperature factor due to Young's modulus TF_{y}.

In Equation 8, known fluid density ρ_{ref} further depends on TFe, an expansion temperature correction for density. The expansion temperature correction for density TFe may be determined using any method known to those of skill in the art. In embodiments, step 314 may further comprise step 312. In step 312, an expansion temperature correction for density TFe may be determined based on empirical data relating to flow tube material expansion.

In embodiments, the expansion temperature correction for density TFe may be non-linear. For example, the article “Low temperature thermal expansion of iron-chromium-nickel alloys of different stabilities” published by Academy of Sciences, Ukraine in February 1978 provides the following polynomial Equation 10 describing the temperature correction for thermal expansion at cryogenic temperatures:

TFₑ=1+16.061*10⁻⁶*temp+5.65*10⁻⁹*temp²−6.007*10⁻¹¹*temp³. (Equation 10)

In embodiments of step 312, the known temperature temp_{ref} may be used to determine the expansion temperature correction for density TFₑ.

Using the known fluid density ρ_{ref}, the phase difference ΔT, the fluid pressure P, the known fluid temperature temp_{ref}, and the time period Tp, it is therefore possible to determine the Young's modulus temperature correction for density TF_{yd} via Equation 11:

$${TF}_{yd} = \frac{( {ρ}_{ref} + \frac{{C}_{2}}{{TF}_{e}^{3} * {PF}_{C 2}} + FD * {( Δ T )}^{2} * 1 {0}^{- 9} ) ( {TFe}^{2} )}{{T}_{p}^{2} {PF}_{C 1} {C}_{1}} . \qquad ( Equation 11 )$$

Because the Young's modulus of the flow tubes affects the vibration of flow tubes 130, 130′, both the mass flow measurement \dot{m} and the fluid density measurement p are affected by changes in Young's modulus. The vibration of the tubes is a function of the flow tube 130, 130′ material properties, and the flow tubes 130, 130′ are typically fabricated from steel.

In further embodiments, however, the flow effect on the fluid density represented by the FD*(ΔT)²*10⁻⁹ term in Equation 11, may be very small, and therefore ignored. In addition, pressure factors for C1, PFC1 and PFC2, may also represent small changes in the Young's modulus temperature correction for density TF_{yd}. Setting the flow effect on fluid density FD to zero and pressure factors PFC1 and PFC2 to 1, may provide for the simplified representation of Young's modulus temperature correction for density TF_{yd} of Equation 12:

$${TF}_{yd} = \frac{( {ρ}_{ref} + \frac{{C}_{2}}{{TF}_{{e}^{*}}^{3}} ) ( {TFe}^{2} )}{{T}_{p}^{2} {C}_{1}} . \qquad ( Equation 12 )$$

According to Equation 12, the Young's modulus temperature correction for density TF_{yd} may be determined based only on known fluid density ρ_{ref}, the known fluid temperature temp_{ref}, and the time period Tp.

Once the Young's modulus temperature correction for density TF_{yd} is determined, method 300 may continue with step 316. In step 316, a Young's modulus temperature correction for mass flow TFy_{M} is determined based on a temperature correction constant k multiplied by Young's modulus temperature correction for density TFy_{D}, as represented by Equation 13:

TF_{ym}=k*TF_{yD} (Equation 13)

The Young's modulus temperature correction for mass flow TFy_{M} is generally related to torque in the flow tubes and the Young's modulus temperature correction for density TFy_{D} is generally related to bending in the flow tubes. Initial tests in a calibration lab using a flow meter with stainless steel tubes shaped in a “U” configuration have indicated these temperature corrections to be substantially similar in value. Therefore, in embodiments the temperature correction constant k may be set to one. It is possible, however, that future tests with more sensitive measurements, different tube materials, and/or different tube geometries may reveal that the Young's modulus temperature correction for mass flow TFy_{M} and the Young's modulus temperature correction for density TFy_{D} are different in value. Therefore, in other embodiments, the temperature correction constant k may be determined to be any number other than one. In one non-limiting example, k may be set to a value between 0.8 and 1.2.

Once the Young's modulus temperature correction for mass flow TFy_{M} is determined, method 300 may continue with step 320. In step 320, a mass flow value \dot{m} determined using Equation 1 with Coriolis flow meter 100 is corrected using the Young's modulus temperature correction for mass flow TFy_{M}. In embodiments, the mass flow value \dot{m} may be corrected using the Young's modulus temperature correction for mass flow TFy_{M} via any method known to those of skill in the art.

In embodiments, step 320 may further comprise step 318, In step 318, a mass error value Errorₘ may be determined using the Young's modulus temperature correction for mass TFy_{M} and the expansion temperature correction for density TFe determined via steps 312 and 316:

$$( Equation 14 )$$

$${Error}_{m} = ( ( \frac{{TF}_{ym - cal} ⋆ {TF}_{e - cal} ⋆ {PF}_{m - cal} ( 1 + \frac{{error}_{cal} \%}{100} - \frac{{Q}_{m - zero - cal}}{{Q}_{m - cal}} )}{{MF}_{m - cal} * {TF}_{m - c a l} * {PF}_{m - c a l}} ) * ( \frac{{MF}_{m - oper} {TF}_{m - oper} {PF}_{m - oper}}{{TF}_{ym} {TF}_{e} {PF}_{m - oper}} ) - 1 ) .$$

### In Equation 14:

Q_{m-zero-cal} is the zero flow mass flow rate measured during factor calibration with a calibration fluid;
Q_{m-cal} is the mass flow rate measured during factory calibration with the calibration fluid;
PF_{m-real-cal} is a real pressure factor determined during calibration;
PF_{m-cal} is an applied pressure factor determined during calibration;
PFₘ₋ₒₚₑᵣ is an applied pressure factor determined during operation;
PFₘ₋ᵣₑₐₗ₋ₒₚₑᵣ is real pressure factor determined during operation;
Error_{cal%} is the meter error determined during calibration;
MF_{m-cal} is a meter-specific factor for mass determined during calibration;
MFₘ₋ₒₚₑᵣ is a meter-specific factor for mass determined during operation;
TF_{e-cal} is an expansion temperature correction for density determined during calibration; and
TFy_{m-cal} is a mass temperature correction for density determined during calibration.

The first part of Equation 14 comes from calibration and reflects the mass error value Errorₘ at 0° C. and 0 barg, and the second part of Equation 14 comes from operation in the application and reflects the error from 0° C. and 0 barg to operating conditions. In practice, the first part of Equation 14 is small in relation to the second part, however. For that reason, in embodiments Equation 14 may be simplified to Equation 15:

$${Error}_{m} = ( \frac{{MF}_{m - oper} {TF}_{m - oper} {PF}_{m - oper}}{{TF}_{ym} {TF}_{e} {PF}_{m - oper}} ) - 1. \qquad ( Equation 15 )$$

In embodiments, a meter factor MF may be determined to correct the mass flow value \dot{m} measured with Coriolis flow meter 100 using Equation 16:

$$MF = \frac{1}{1 + \frac{{Error}_{m}}{100}} . \qquad ( Equation 16 )$$

A corrected mass flow value \dot{m} may then be determined by multiplying the measured mass flow value \dot{m} by meter factor MF.

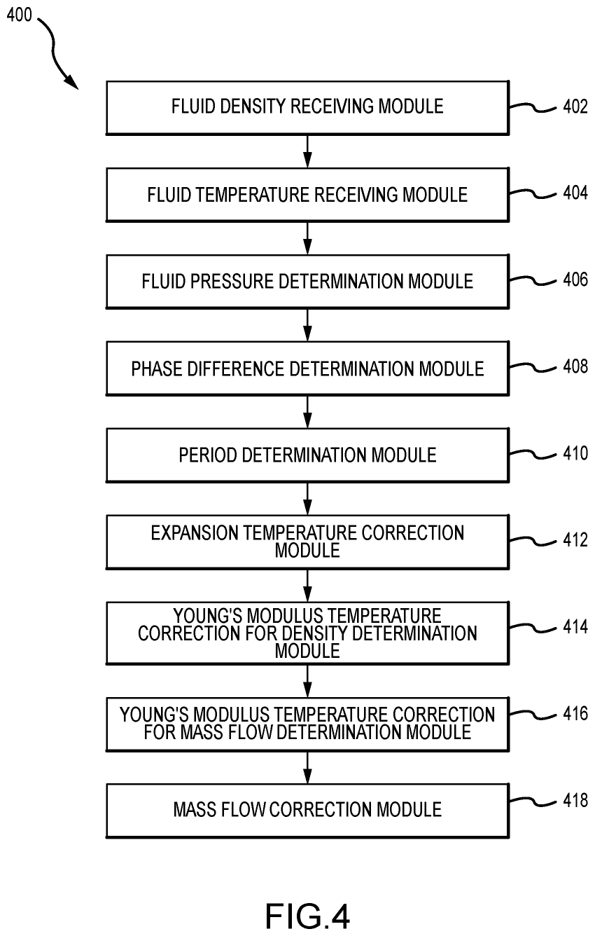

FIG. 4 depicts system 400. In embodiments, system 400 may be used to correct a mass flow value \dot{m} measured using a Coriolis flow meter 100 for temperature effects at a fluid temperature temp below 0 C. System 400 comprises fluid density receiving module 402, fluid temperature receiving module 404, period determination module 410, Young's modulus temperature correction for density determination module 414, Young's modulus temperature correction for mass flow determination module 416, and mass flow correction module 418. In embodiments, system 400 may further comprise fluid pressure determination module 406, phase difference determination module 408, and expansion temperature correction module 412.

Fluid density receiving module 402 is configured to determine a fluid density p, such as, for example, the known fluid density ρ_{ref}. For example, fluid density receiving module 402 may execute step 302, described above.

Fluid temperature receiving module 404 is configured to determine the fluid temperature temp, such as, for example, the known fluid temperature temp. For example, fluid temperature receiving module 404 may execute step 304, as described above.

Fluid pressure determination module 406 is configured to determine a fluid pressure P. For example, fluid pressure determination module 406 may execute step 306, as described above.

Phase difference determination module 408 is configured to determine a phase difference ΔT. For example, phase difference determination module 408 may execute step 308, as described above.

Period determination module 410 is configured to receive a time period Tp. For example, period determination module 410 may execute step 310, as described above.

Expansion temperature correction module 412 is configured to determine an expansion temperature correction for density TFe. For example, expansion temperature correction module 412 may execute step 312, as described above.

Young's modulus temperature correction for density determination module 414 is configured to determine a Young's modulus temperature correction for density TFy_{D} based on the fluid density ρ, the fluid temperature temp, and the time period Tp. For example, Young's modulus temperature correction for density determination module 414 may execute step 314, as described above.

Young's modulus temperature correction for mass flow determination module 416 is configured to determine a Young's modulus temperature correction for mass flow TFy_{M} based on a temperature correction constant k and Young's modulus temperature correction for density TFy_{D}. For example, Young's modulus temperature correction for mass flow determination module 416 may execute step 316, as described above.

Mass flow correction module 418 is configured to correct the mass flow value \dot{m} using the Young's modulus temperature correction for mass flow TFy_{M}. For example, mass flow correction module 418 may execute step 318, as described above.

Tests on liquified nitrogen at a cryogenic calibration facility using a weighing scale have determined that the methods and system of the present Application provide a corrected mass flow value \dot{m} with errors that are less than 0.10%. Some of the tests conducted by the Applicant provided mass flow errors that were as low as 0.07% and 0.01% for flow meters with flow tubes that are four inches or less in diameter. The methods and system described in the present Application can be extrapolated to larger meter sizes, or those with flow tube diameters that are greater than four inches, to provide very accurate mass flow values m for higher fluid flows.

The methods and system described by the present Application provide temperature corrections that improve the accuracy of mass flow measurements generated with Coriolis flow meters at sub-zero and cryogenic temperatures. The temperature corrections are stable over time, and do not require calibration of the Coriolis flow meter at a cryogenic calibration facility.

The detailed descriptions of the above examples are not exhaustive descriptions of all examples contemplated by the inventors to be within the scope of the Application. Indeed, persons skilled in the art will recognize that certain elements of the above-described examples may variously be combined or eliminated to create further examples, and such further examples fall within the scope and teachings of the Application. It will also be apparent to those of ordinary skill in the art that the above-described examples may be combined in whole or in part to create additional examples within the scope and teachings of the Application. Accordingly, the scope of the Application should be determined from the following claims.

We claim:

1. A method for correcting a mass flow value \dot{m} measured using a Coriolis flow meter (100) for temperature effects at a known fluid temperature temp below 0 C, the method comprising:
receiving a known fluid density ρ_{ref};
receiving the known fluid temperature temp;
receiving a time period Tp;
determining a Young's modulus temperature correction for density TFy_{D} based on the known fluid density ρ_{ref}, the known fluid temperature temp, and the time period Tp;
determining a Young's modulus temperature correction for mass flow TFy_{M} based on a temperature correction constant k and the Young's modulus temperature correction for density TFy_{D}; and
correcting the mass flow value \dot{m} using the Young's modulus temperature correction for mass flow TFy_{M}.

2. A method as claimed in claim 1, wherein the time period Tp is determined based on a measured fluid density ρ_{indic}.

3. A method as claimed in claim 1, further comprising:
receiving a phase difference ΔT, and
wherein determining the Young's modulus temperature correction for density TFy_{D} is further based on the phase difference ΔT.

4. A method as claimed in claim 1, further comprising:
receiving a fluid pressure P,
and wherein the Young's modulus temperature correction for density TFy_{D} is further based on the fluid pressure P.

5. A method as claimed in claim 1, wherein the method further comprises:
determining an expansion temperature correction for density TFe,
and wherein the Young's modulus temperature correction for density TFy_{D} is further determined based on the expansion temperature correction for density TFe based on a known temperature temp_{ref}.

6. A method as claimed in claim 1, wherein the temperature correction constant k is between 0.8 and 1.2.

7. A method as claimed in claim 1, wherein the temperature correction constant k is one.

8. A method as claimed in claim 1, wherein correcting a mass flow value \dot{m} using the Young's modulus temperature correction for mass flow TFy_{M} further comprises:
determining a mass error value Errorₘ using the Young's modulus temperature correction for mass TFy_{M}.

9. A system (400) for correcting a mass flow value \dot{m} measured using a Coriolis flow meter (100) for temperature effects at a known fluid temperature temp below 0 C, the system (400) comprising:
a fluid density receiving module (402) configured to receive a known fluid density ρ_{ref};
a fluid temperature receiving module (404) configured to receive the known fluid temperature temp;
a period determination module (410) configured to receive a time period Tp;
a Young's modulus temperature correction for density determination module (414) configured to determine a Young's modulus temperature correction for density TFy_{D} based on the known fluid density ρ_{ref}, the known fluid temperature temp, and the time period Tp;
a Young's modulus temperature correction for mass flow determination module (416) configured to determine a Young's modulus temperature correction for mass flow TFy_{M} based on a temperature correction constant k and the Young's modulus temperature correction for density TFy_{D}; and
a mass flow correction module (418) configured to correct the mass flow value \dot{m} using the Young's modulus temperature correction for mass flow TFy_{M}.

10. A system (400) as claimed in claim 9, wherein the fluid density receiving module (402) is further configured to determine a measured fluid density ρ_{indic}, and the period determination module (410) is further configured to determine the time period Tp based on the measured fluid density ρ_{indic}.

11. A system (400) as claimed in claim 9, further comprising:
a phase difference determination module (408) configured to determine a phase difference ΔT, and
wherein the Young's modulus temperature correction for density determination module (414) is further configured to determine the Young's modulus temperature correction for density TFy_{D} based on the phase difference ΔT.

12. A system (400) as claimed in claim 9, the system further comprising:
a fluid pressure determination module (406) configured to determine a measured fluid pressure ρ_{indic}, and
and wherein the Young's modulus temperature correction for density determination module (414) is further configured to determine the Young's modulus temperature correction for density TFy_{D} based on the fluid pressure P.

13. A system (400) as claimed in claim 9, wherein the system (400) further comprises:
an expansion temperature correction module (412) configured to determine an expansion temperature correction for density TFe based on a known temperature temp_{ref},
and wherein the Young's modulus temperature correction for density module (414) is further configured to determine the Young's modulus temperature correction for density TFy_{D} based on the expansion temperature correction for density TFe.

14. A system (400) as claimed in claim 9, wherein the temperature correction constant k is between 0.8 and 1.2.

15. A system (400) as claimed in claim 9, wherein the temperature correction constant k is one.

16. A system (400) as claimed in claim 9, wherein the mass flow correction module (418) is further configured to determine a mass error value Errorₘ using the Young's modulus temperature correction for mass TFy_{M}.

17. A meter electronics (20) for correcting a mass flow value \dot{m} measured using a meter assembly (10) of a Coriolis flow meter (100) for temperature effects at a known fluid temperature temp below 0 C, the meter electronics comprising a system processor (20b) configured to:
receive a known fluid density ρ_{ref};
receive the known fluid temperature temp;
receive a time period Tp;
determine a Young's modulus temperature correction for density TFy_{D} based on the known fluid density ρ_{ref}, the known fluid temperature temp, and the time period Tp;
determine a Young's modulus temperature correction for mass flow TFy_{M} based on a temperature correction constant k and Young's modulus temperature correction for density TFy_{D}; and
correct the mass flow value \dot{m} using the Young's modulus temperature correction for mass flow TFy_{M}.

18. A meter electronics (20) as claimed in claim 17, wherein the time period Tp is determined based on a measured fluid density ρ_{indic}.

19. A meter electronics (20) as claimed in claim 17, wherein system processor (20b) is further configured to receive a phase difference ΔT, and
wherein determining the Young's modulus temperature correction for density TFy_{D} is further based on the phase difference ΔT.

20. A meter electronics (20) as claimed in claim 17, wherein the system processor (20b) is further configured:
to receive a fluid pressure P, and
wherein the Young's modulus temperature correction for density TFy_{D} is further based on the fluid pressure P.

21. A meter electronics (20) as claimed in claim 17, wherein the system processor 20b is further configured to:
determine an expansion temperature correction for density TFe,
and wherein the Young's modulus temperature correction for density TFy_{D} is further determined based on the expansion temperature correction for density TFe based on a known temperature temp_{ref}.

22. A meter electronics (20) as claimed in claim 17, wherein the temperature correction constant k is between 0.8 and 1.2.

23. A meter electronics (20) as claimed in claim 17, wherein the temperature correction constant k is one.

24. A meter electronics (20) as claimed in claim 17, wherein correcting a mass flow value \dot{m} using the Young's modulus temperature correction for mass flow TFy_{M} further comprises:
determining a mass error value Errorₘ using the Young's modulus temperature correction for mass TFy_{M}.
